(19) United States
(12) Patent Application Publication
(10) Pub. No.: US 2013/0041568 A1
(43) Pub. Date: Feb. 14, 2013

(54) Fuel off warning

(71) Applicant: Charles Joseph Lirette, Holly Springs, MS (US)

(72) Inventor: Charles Joseph Lirette, Holly Springs, MS (US)

(21) Appl. No.: 13/507,841

(22) Filed: Aug. 1, 2012

Related U.S. Application Data
(60) Provisional application No. 61/574,880, filed on Aug. 12, 2011.

(51) Int. Cl. G01M 15/00

(52) U.S. Cl. 701/101

(57) ABSTRACT

A “Fuel off Warning” system comprising:

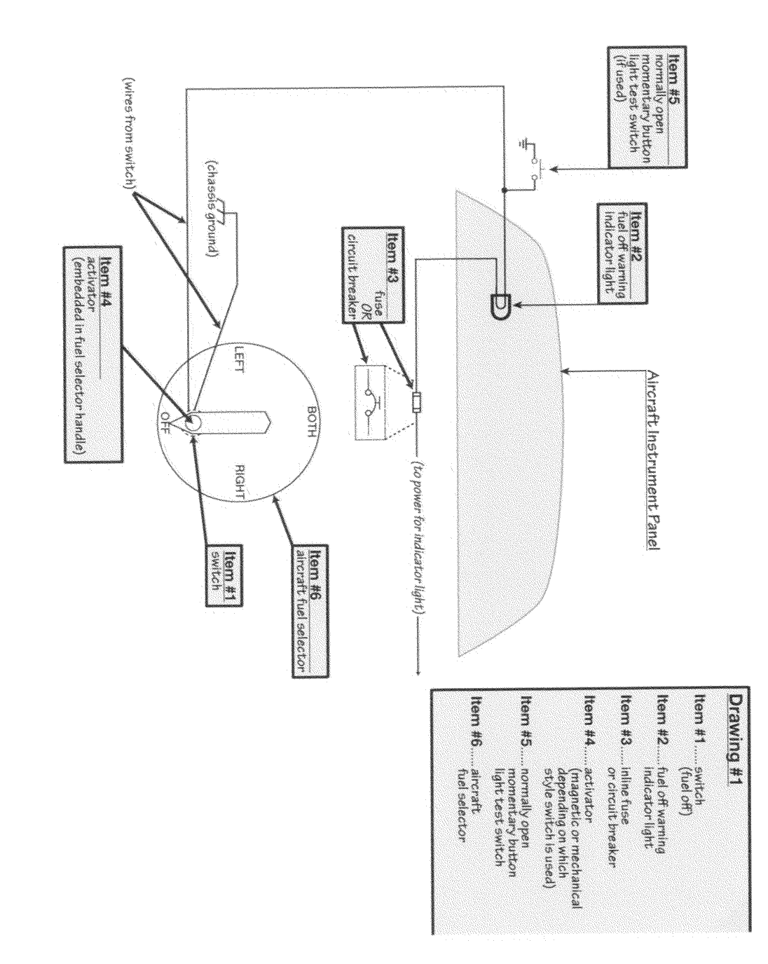

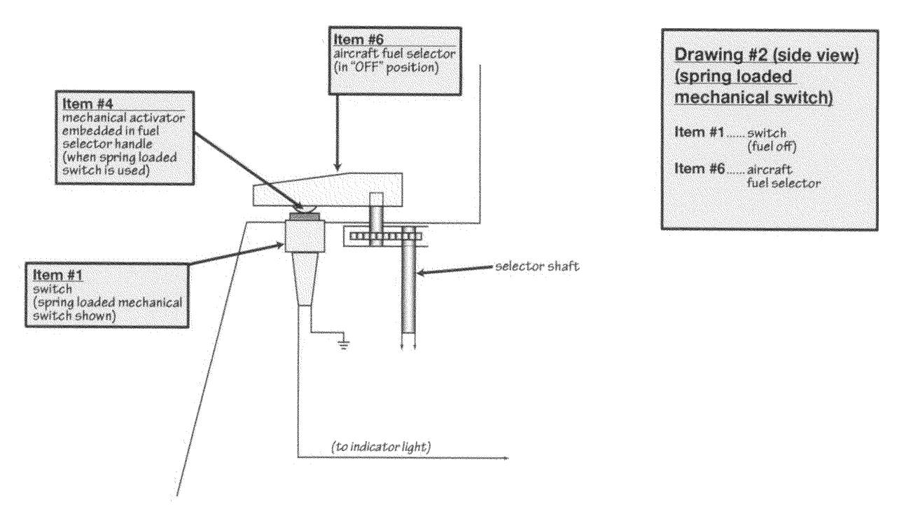

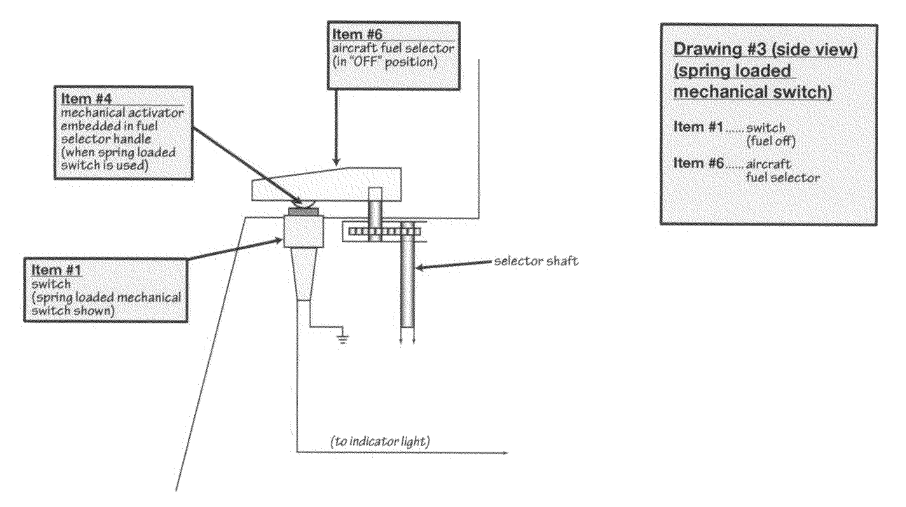

At least approximately one switch; at least approximately one switch activator; at least approximately one indicator light; at least approximately one selector. Sufficient wiring configured to connect the switch, activator and light; where the switch is configured to be activated by the activator causing the indicator light to illuminate. Wherein the activator is configured within the selector;
(a) When the indicator light illuminates, thus indicating the selector is in the OFF position.
(b) When the selector is moved away from the OFF position, said indicator light ceases to be illuminated (is extinguished).

In addition, there may be a momentary switch configured to test the indicator light for proper operation, separate and apart from the switch.

### RELATED APPLICATION

This Application Claims Priority to U.S. Provisional Patent Application No. 61/574,880

Filed: Aug. 12, 2011

Entitled “FUEL OFF WARNING”

### BACKGROUND

A “Fuel off Warning” system is a system intended to deter an operator/pilot from attempting to start a vehicle with the fuel source turned to the off position. In more than a few instances operators of vehicles, most commonly but not limited to light aircraft, were able to start the vehicle's engine with the fuel selector in the off position. This occurs when some systems have fuel trapped or stored downstream of the fuel selector/shutoff valve. In those instances when the engine was started with the fuel shut off, the engine was able to function until fuel remaining in the line was depleted. At that time the engine suddenly stopped due to fuel starvation. In many instances this resulted in severe injury or death.

### SUMMARY OF THE INVENTION

According to the embodiment of this present invention, the “Fuel off Warning” system uses a switch located adjacent to or near the fuel selector handle. The switch is configured to be in very close proximity to the fuel selector handle when in the OFF position. The selector handle has within it a switch activator. When the switch is activated, the switch configured to a “Fuel off Warning” indicator light causes the indicator light to illuminate, thus informing the operator that the fuel selector is in the OFF position. Moving the selector to any different position than OFF deactivates the switch, extinguishing the indicator light.

### BRIEF DESCRIPTION OF DRAWINGS

Drawing no. 1 depicts a view of the “Fuel off Warning” system with preferred embodiments.

Drawing no. 2 depicts a side view of a portion of the “Fuel off Warning” system utilizing a preferred magnetic proximity switch and magnetic activator.

Drawing no. 3 depicts a side view of a portion of the “Fuel off Warning” system utilizing a mechanical switch and activator.

### DETAILED DESCRIPTION OF DRAWINGS

Drawing no. 1 depicts an overview of the “Fuel off Warning” system comprising at least one switch (item no. 1), mechanical or magnetic type, preferably a magnet proximity type; at least one activator (item no. 4), mechanical or magnetic type, preferably a magnet; at least one indicator light (item no. 2) , preferably an LED type; at least one selector handle (item no. 6); at least one circuit protection device (item no. 3); at least one momentary switch, push button type (item no. 5) if used.

The switch (item no. 1) is configured as to be activated when the activator (item no. 4), which is located within the selector (item no. 6), comes within close proximity to the switch (item no. 1). When the switch (item no 1) is activated it causes the indicator light (item no. 2) to be illuminated. In addition, a momentary switch (item no. 5) if used, is configured as to cause the indicator light (item no. 2) to illuminate apart from the switch (item no. 1) in order to test the indicator light (item no. 2). The circuit protection device (item no. 3) is used to protect the system.

Drawing no. 2 depicts a side view of a preferred configuration (magnetic proximity type) of the switch (item no. 1), and the activator (item no. 4), which is located within the selector (item no. 6).

Drawing no. 3 depicts a side view of a mechanical type switch (item no. 1) and mechanical activator (item no. 4) which is located on the selector (item no. 6).

### Method

The scope of this present invention would most preferably be used in a vehicle, most preferably in aircraft. The use of this “Fuel off Warning” system will greatly enhance the safety aspects of the operation of the vehicle. As stated previously, there have been numerous instances of operators/pilots experiencing engine failure in certain vehicles/aircraft in which the engine/engines are configured to be started with the fuel selector in the OFF position. When this “Fuel off Warning” system is used, as soon as the vehicles power is turned on the indicator light will illuminate, if and when the fuel selector is in the OFF position. This indicator would most preferably be located directly in front of the operator/pilot of vehicle/aircraft. This “Fuel off Warning” system as referenced within this explanation does not interfere, impede or conflict with any of the vehicle's critical systems. It is light-weight, simple in design, and has minimal effect on power loads.

I claim:

1. A “Fuel off Warning” system comprising:
At least approximately one switch;
At least approximately one switch activator;
At least approximately one indicator light;
At least approximately one selector;
Sufficient wiring configured to connect said switch, activator and light;
Wherein said switch is configured to be activated by said activator, causing said indicator light configured to illuminate.
Wherein the activator is configured within the selector;
(a) When the indicator light illuminates, thus indicating the selector is in the OFF position. (b) When the selector is moved away from the OFF position said indicator light ceases to be illuminated (is extinguished).

2. The “Fuel off Warning” system, as in claim 1, further comprises a circuit protection device appropriate for the application of the system as related to the vehicle/aircraft in which the system is used i.e.: fuse, circuit breaker or current limiter.

3. The “Fuel off Warning” system, as in claim 1, comprising: the switch, preferably a magnetic proximity switch; the activator, preferably a magnet located within the selector; the indicator light, preferably a LED type would be configured in such a location to be obvious to the operator/pilot of the “Fuel off Warning” system.

4. The “Fuel off Warning” system as in claim 1. Further comprising a momentary test switch configured to test said indicator light, for proper operation by supplying an electrical ground to the indicator light, separate and apart from the switch.

5. As in claim 1. A “Fuel off Warning” system comprising:
At least approximately one switch;
At least approximately one switch activator;
At least approximately one indicator light;
At least approximately one selector;
At least one circuit protection device;
Sufficient wiring configured to connect said switch, activator and light, wherein said switch is configured to be activated by said activator, causing said indicator light configured to illuminate.
Wherein the activator is configured within the selector;
(a) When the indicator light illuminates, indicates the selector is in the OFF position.
(b) When the selector is moved away from the OFF position, said indicator light ceases to be illuminated (is extinguished).
(c) Further indicator lamp would preferably be red in color, with use of a red colored lens or any method of coloring the indicator.

6. A “Fuel off Warning” system comprising:
At least approximately one switch, preferably a magnetic proximity type.
At least approximately one switch activator, preferably a magnet.
At least approximately one indicator light, preferably of LED type.
At least approximately one selector.
At least approximately one circuit protection device.

7. A “Fuel off Warning” system for use preferably in aircraft, comprising;
At least approximately one switch;
At least approximately one switch activator;
At least approximately one indicator light;
At least approximately one selector;
Sufficient wiring configured to connect said switch, activator and light, wherein said switch is configured to be activated by said activator, causing said indicator light configured to illuminate.
Wherein the activator is configured within the selector;
(a) When the indicator light illuminates, thus indicating the selector is in the OFF position.
(b) When the selector is moved away from the OFF position, said indicator light ceases to be illuminated (is extinguished).
